(19) United States
(12) Patent Application Publication
(10) Pub. No.: US 2015/0178614 A1
(43) Pub. Date: Jun. 25, 2015

(54) Security Label

(71) Applicant: Smart Approach Co., Ltd., Hsinchu County (TW)

(72) Inventor: Hsin-Lung Lin, Hsinchu County (TW)

(21) Appl. No.: 14/543,975

(22) Filed: Nov. 18, 2014

(30) Foreign Application Priority Data
Dec. 19, 2013 (TW) 102147049
Jul. 21, 2014 (TW) 103125009

(51) Int. Cl. G06K 19/073; H04W 4/00; G06Q 10/08

(52) U.S. Cl. CPC G06K 19/07372; G06Q 10/087; H04W 4/008

(57) ABSTRACT

A security label is provided, and the security label is configured to being read by a reader device. The security label comprises a substrate, an extending circuit, and a signal processor. The extending circuit is disposed on the substrate. The signal processor is disposed on the substrate. The signal processor further has an input terminal. The input terminal is connected to the extending circuit. When the electrical potential of the input terminal is changed, a status of one bit of the signal processor is reversed.

### BACKGROUND OF THE INVENTION

1. Field of the Invention

The invention relates to a security element, and more particularly relates to a security label.

2. Description of the Prior Art

In general, goods of higher prices such as vantage bottled wines are more likely to be switched and stolen during their transportations. Some unworthy vendors may replace high-ranked wine with low-quality wine. Alternatively, some unworthy vendors may recycle empty bottles of high-ranked wine, pour low-quality wine into the empty bottles, and sell them at high price. It is a big impact for original wine vendors. Therefore, most wine vendors would dispose security elements on the bottles of wine to avoid infringement by unworthy vendors.

Currently, some wine vendors use RF (radio-frequency) chips to avoid counterfeit. A RF chip is disposed on the inside surface of a bottle cap of an unopened bottle and it has several wires which are linked with a plurality of metal wires on the bottle cap. A circuit is formed by the metal wires and an antenna on the bottle body. The bottle cap has a blade between the RF chip and the antenna. Once the bottle is opened, the blade will destroy the antenna. Without the functional antenna, the RF chip can't get enough excitation voltage, so it fails to work. This method enables security.

However, this method may be cracked by unworthy vendors. They can remake the antenna, and link it with the RF chip again. Therefore, the unworthy vendors can still sell counterfeit wine at high prices.

Therefore, how to design a security label so as to effectively avoid infringements by unworthy vendors is worthy considering for a person having ordinary skill in the art.

### SUMMARY OF THE INVENTION

One object of the present invention is to provide a security label. The security label includes a substrate, an extending circuit, and a signal processor. The extending circuit and the signal processor are disposed on the substrate. A voltage source outputs an electrical potential to the signal processor via the extending circuit. A tear line spanned the. extending circuit is disposed on the substrate. When the tear line is torn, the electrical potential received by the signal processor is changed, and a status of one bit of the signal processor is reversed. The bit of the signal processor is protected by encryption, so the bit of the signal processor is hardly or cannot to be reversed again. Therefore, even though the security label is recycled and remade by unworthy vendors, and the extending circuit is connected to the signal processor again, the status of the bit of the signal processor has been reversed. Therefore, the status of the bit of the signal processor can be sensed by NFC method to confirm whether it is reversed or not, so as to confirm whether the security label is counterfeited or not.

Furthermore, by using a smart phone which have special app and NFC function to sense the security label, the consumer can confirm whether the commodity is counterfeited or not. At the same time, the information of the security label is uploaded to a cloud database, so the status of security label can be further tracked. Beside, the information of the commodity is saved in the cloud database, so the consumer can use the smart phone to browse the information of the commodity

Therefore, when the security label of the invention is disposed on the wrapper of the commodity, the costumer can use the smart phone to sense the security label, so as to confirm whether the commodity is counterfeited or not. The status of the bit of the signal processor is hardly reversed or cannot be reversed. Thus, the security label of the present invention is hardly counterfeited, and the counterfeiting of unworthy vendor also can be prevented.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 shows an embodiment of the security label of invention.

FIG. 2 shows a detail construction block diagram of signal processor.

FIG. 3 shows the security label of the invention used on a wine bottle.

FIG. 4 shows a broken security label.

FIG. 5 shows a security label having wavy tear line.

FIG. 6 shows a second embodiment of the security label of the invention.

FIG. 7 shows a third embodiment of the security label of the invention.

FIG. 8 shows a fourth embodiment of the security label of the invention.

FIG. 9 shows a fifth embodiment of security label of the invention.

FIG. 10 shows a flow diagram of the operation of the security label.

### DESCRIPTION OF THE PREFERRED EMBODIMENTS

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiment illustrated.

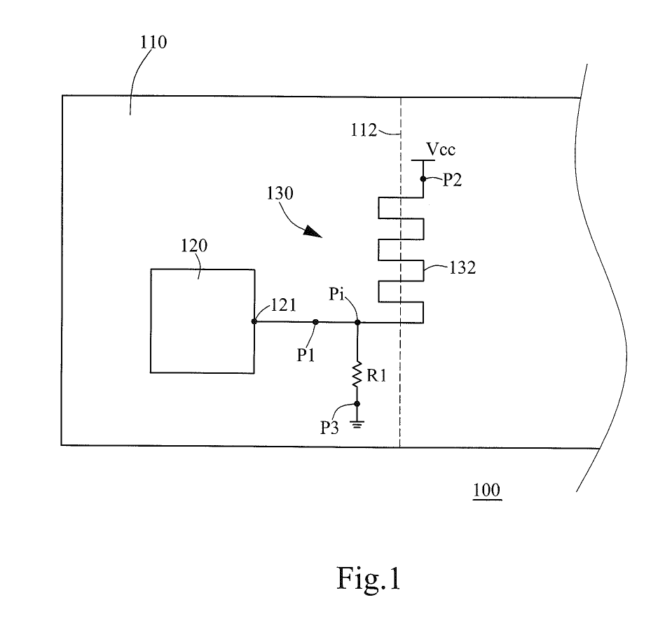

Please refer to FIG. 1. FIG. 1 is a diagram illustrating one embodiment of the security label of the invention. The security label 100 comprises a substrate 110, a signal processor 120, and an extending circuit 130. The substrate 110 has a tear line 112 thereon. The tear line 112 for example is formed by a plurality of holes arrayed equidistant. The signal processor 120 is disposed on the substrate 110. The signal processor 120 is capable of receiving an electromagnetic wave and converting the electromagnetic wave into a DC voltage to supply energy for the operation of the signal processor 120. In this embodiment, the frequency of the electromagnetic wave is between 3 MHz and 30 MHz, but it can also be set in other frequency. The extending circuit 110 is also disposed on the substrate 110 and comprises a plurality of bends 132.

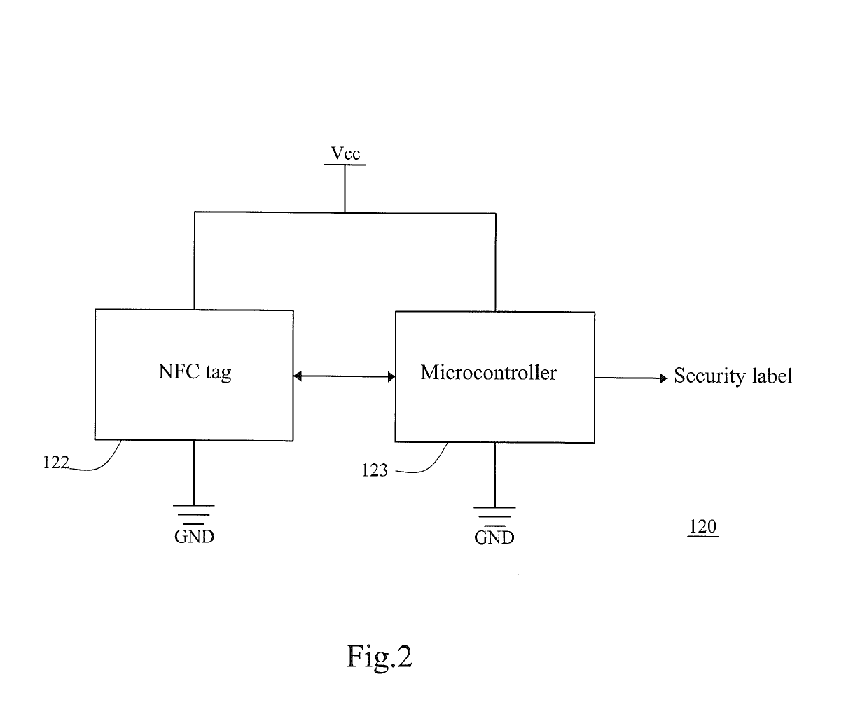

Please still refer to FIG. 1. The extending circuit 130 further comprises a first terminal P1, a second terminal P2, a third terminal P3, and an inner terminal Pi. The inner terminal Pi is connected to the first terminal P1, the second terminal P2, and the third terminal P3. The first terminal P1 is connected to one input terminal 121 of the signal processor 120. The input terminal 121 for example is a general purpose I/O (GPIO) terminal of the signal processor 120. The second terminal P2 is connected to a DC voltage source Vcc. The third terminal P3 is connected to ground (i.e. grounding). In additional, the first resistor R1 is disposed on the extending circuit 130. The first resistor R1 and the signal processor 120 are connected to the inner terminal Pi in parallel. The inner terminal Pi is connected to the third terminal P3 via the first resistor R1. In this embodiment, the tear line 110 on the substrate 110 spans between the inner terminal Pi and the second terminal P2. Please refer to FIG. 2. FIG. 2 shows a detail construction block diagram of signal processor. The signal processor 120 includes a NFC tag 122 and a microcontroller 123. The NFC tag 122 is connected to the microcontroller 123 mutually. The NFC tag 122 further includes a NFC controller circuit connected to the NFC antenna (not drawn in FIG. 2). The microcontroller 123 is connected to the input terminal 121. NFC tag 122 and microcontroller 123 are connected to a DC voltage source Vcc (the DC voltage source Vcc drawn in FIG. 2 is same as the DC voltage source Vcc drawn in FIG. 1). A production resumes of the commodity used the security label is saved in the NFC tag 122. For example: production date, storage time, place of production or constituents, etc.

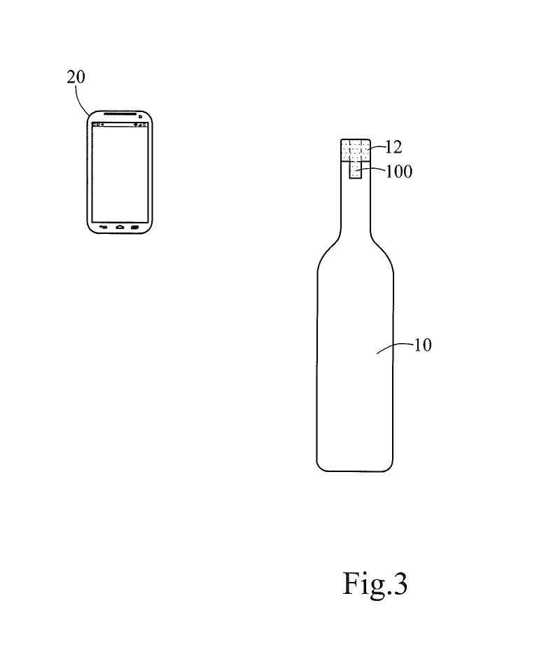

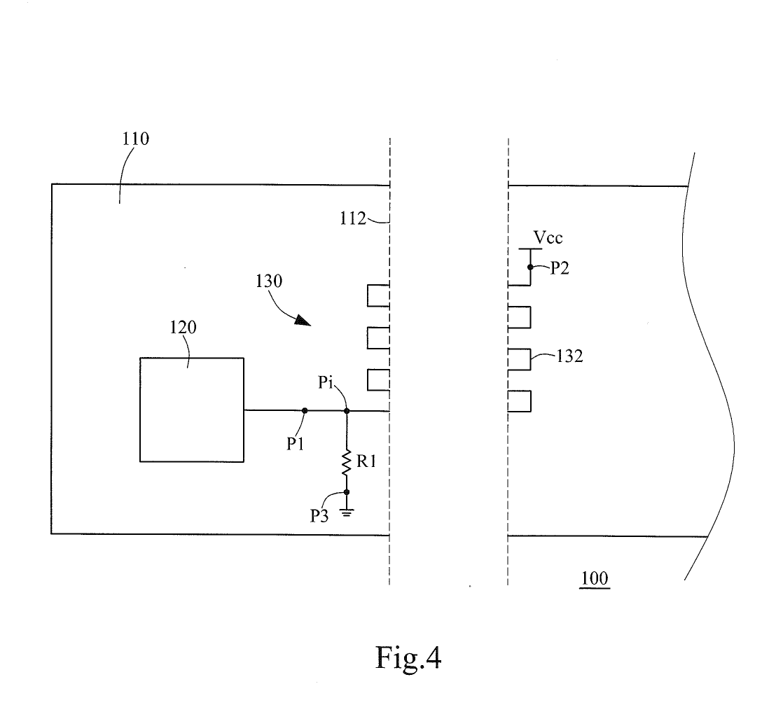

Next, please refer to FIG. 1 and FIG. 3. FIG. 3 is a diagram illustrating the security label of the invention applied to a bottle. A wrapper 12 is attached to the top of a bottle 10 and covers the cap of the bottle 10. One terminal of the wrapper 12 is connected to the security label 100. When a customer wants to open the cap of the bottle 10, he needs to remove the wrapper 12 first and rip the security label 100 off. The ripped security label 100 is broken along the tear line 112. The broken security label 100 is shown in FIG. 4.

Please refer to FIG. 1 and FIG. 3. Before the security label 100 is broken along the tear line 112, if a reader device 20 approaches the security label 100, the electromagnetic wave emitted from the reader device 20 will be read by the NFC antenna of the signal processor 120 of the security label 100. At this moment, the electrical potentials of the first terminal P1 and the inner terminal Pi are equivalent to the electrical potential of the second terminal P2. In other word, the electrical potentials of the first terminal P1, the inner terminal Pi, and the second terminal P2 are higher than the electrical potential of the third terminal P3. Moreover, the microcontroller 123 of the signal processor 120 senses the electrical potential of first terminal P1 (same as the electrical potential of the input terminal 121 of the signal processor 120). If the electrical potential of first terminal P1 is higher than third terminal P3, the status of the bit of the microcontroller 123 is not changed. Therefore, the reader device 20 would determine the bottle 10 is unopened.

Next, please refer to FIG. 3 and FIG. 4. After the security label 100 is broken along the tear line 112, the electrical potentials of the first terminal P1 and the inner terminal Pi would be equivalent to the electrical potential of the third terminal P3. At this moment, the electrical potential of the input terminal 121 of the signal processor 120 is changed, and it means from high electrical potential into low electrical potential. Therefore, a status of one bit of the signal processor 120 is reversed, for example, “0” is turned into “1” or “1” is turned into “0”. Furthermore, the bit can't be reversed again or is hardly to be reversed again. The “hardly to be reversed again” means it needs inputting a password (for example: 128 bit encryption key) so as to reverse the bit.

Since the status of the bit of the microcontroller 123 is reversed, when the reader device 20 tries to read the signal processor 120 of the security label 100, the reader device 20 would detect a reversed status of the bit of the microcontroller 123 and determine the bottle 20 has been opened. Even though the unworthy venders can recycle the used signal processor 120, and remake the security label 100, pour low quality wine into an empty bottle and sell it at high prices, it's impossible or difficult to reverse again the reversed status of bit of the signal processor 120. So, a costumer can use reader device 20 to read the security label 100 and identify authenticity of wine.

In addition, the reader device 20 also reads and shows the information saved in the NFC tag 122 when the reader device 20 approaches the signal processor 120 of the security label 100. Therefore, the consumer also can browse the information of the commodity and determine the state of the commodity when the reader device 20 approaches the security label 100. The NFC tag 122 can be designed as NFC tag having special reading password or program, and only the reader device 20 corresponding the special password or program can read the data of the NFC tag 122.

In the above-mentioned embodiment, the reader device 20 is a smart phone which reads data of the signal processor 120 by wireless method (for example: Near Field Communication, NFC). In this embodiment, application software cooperating with the signal processor 120 is installed in the reader device 20 in advance. When the application software is started, the reader device 20 would launch an electromagnetic wave to the signal processor 120. Upon receiving the electromagnetic wave, the signal processor 120 would convert the electromagnetic wave into a voltage source and transmit certain information to the reader device 20. Then, the application software of the reader device 20 may determine whether the bottle 10 is opened or not and identify the authenticity of wine. Moreover, the reader device 20 can be a device other than smart phone such as a tablet Pc or a specialized card reader. Besides, if reader device 20 has network function, the reader device 20 can transmit the information of the security label 100 to a cloud database via the internet and remind the consumer. For example, when the reader device 20 determines that the security label 100 has been torn, the information of the security label 100 (such as serial numbers, barcode, or the record of the micro controller) would be transmitted to the cloud database and marks the security label 120 as “torn”. If the torn security label 100 is remade and read by the reader device 20 again, the reader device 20 would receive a warning message from the cloud database to remind the consumer this commodity is a fake.

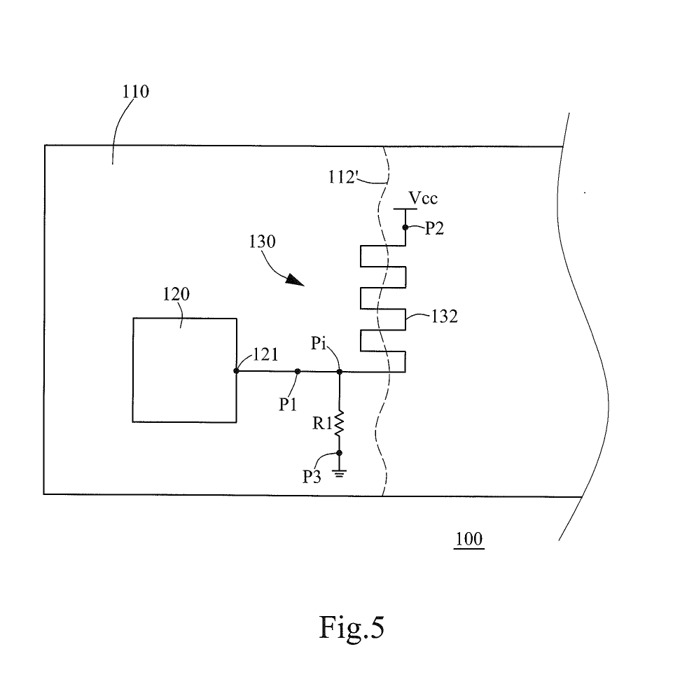

Moreover, the bends 132 disposed in the extending circuit 130 is used to increase difficulty of counterfeiting the extending circuit 130. In this embodiment, these bends 132 together take a square wavy form, but they can be designed into other shape, for example: serrated shape. The tear line 112 is a straight line in this embodiment, but it can be designed into wavy shape (i.e. tear line 112′as shown in FIG. 5). Thus, it can increase difficultly of counterfeiting security label 100.

In the above-mentioned embodiment, the tear line 112 spans between the inner end Pi and the second terminal P2, and there is no resistors between the inner end Pi and the second terminal P2. However, the tear line can be disposed in other location. The location of the resistor can be different from that of the above-mentioned embodiment. In the following embodiment, for clearly expressing the feature of the embodiment, we only draw the circuit diagrams between the signal processor and the extending circuit and the substrate is expressed by dotted line. Beside, in the following embodiment, we only draw the location where the tear line spans in the extending circuit, and don't draw the tear line. But, it should be understood in the following embodiment, the substrate and the tear line of the security label are the same as or similar with the substrate and the tear line of the above-mentioned embodiment. Beside, in the following embodiment, if the same element is marked by the same symbol, it will not be explained again.

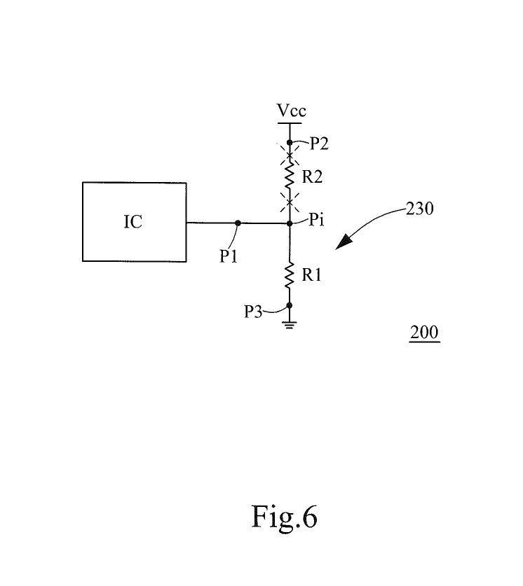

Please refer to FIG. 6. FIG. 6 is a diagram illustrating a second embodiment of the security label of the invention. The extending circuit 230 of the security label 200 has a second resistor R2 besides of the first resistor R1 . The second resistor R2 is connected to the signal processor 120 in parallel. The resistance of the second resistor R2 is lower than the resistance of the first resistor R1. In the preferred embodiment, the resistance of the second resistor R2 is much lower than the resistance of the first resistor R1. In addition, the “X” in FIG. 6 represents the location where the tear line spans in the extending circuit, and the tear line may span between the second end P2 and the second resistor R2, or may span between the inner end Pi and the second resistor R2. Since the resistance of the second resistor R2 is lower than the resistance of the first resistor R1, the electrical potential of the input end 121 of the signal processor 120 may change when the tear line is torn, i.e. it means from high electrical potential into low electrical potential. Particularly, the electrical potential variation would be more obvious when the resistance of the second resistor R2 is much lower than the resistance of the first resistor R1. When the electrical potential of the input end 121 of the signal processor 120 changes, a status of one bit of the signal processor 120 is reversed and it can't be reversed again or is hardly to be reversed again.

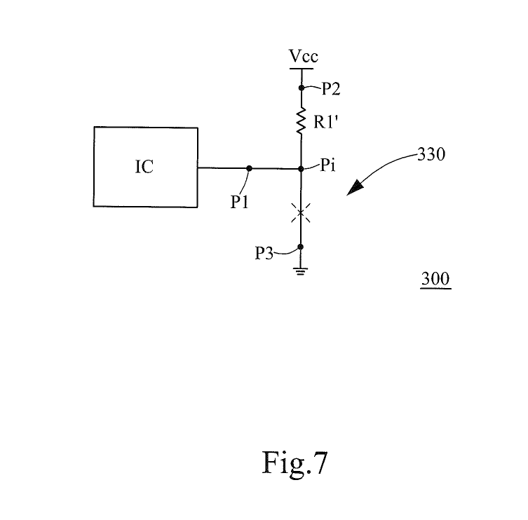

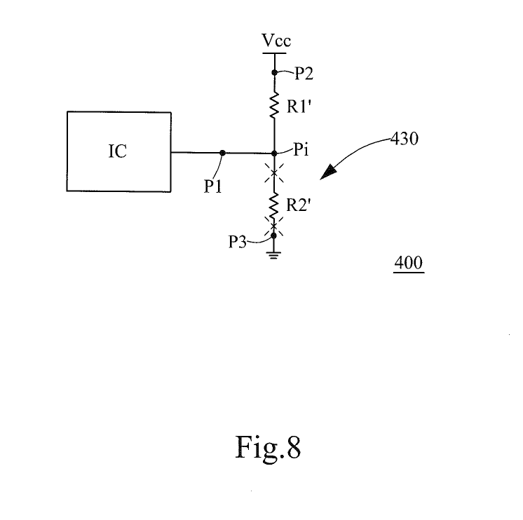

Please refer to FIG. 7. FIG. 7 is a diagram illustrating a third embodiment of the security label of the invention. The extending circuit 330 has a first resistor R1′ which is disposed between the inner terminal Pi and the second terminal P2, and the first resistor R1′ and the signal processor 120 are connected to the inner terminal Pi in parallel. Besides, the tear line spans between the inner terminal Pi and the second terminal P2 (location of “X” in the FIG. 6). The electrical potentials of the first terminal P1 and the inner terminal Pi are the same with the electrical potential of the third terminal P3 before the tear line is torn, and it is regarded as grounding. However, when the tear line is torn, since the connection between the inner terminal Pi and the third terminal P3 is broken, the electrical potential of the inner terminal Pi would be equivalent to or resemble the electrical potential of the second terminal P2. In other word, the electrical potential of the input terminal 121 of the signal processor 120 is changed, it means from low electrical potential into the high electrical potential. When the electrical potential of the input terminal 121 of the signal processor 120 changes, a status of one bit of the signal processor 120 is reversed, and it can't be reversed again or is hardly to be reversed again. Please refer to FIG. 8. FIG. 8 is a diagram illustrating a fourth embodiment of security label of the invention. The extending circuit 430 has a second resistor R2′ besides of the first resistor R1′, the second resistor R2′ is connected to the signal processor 120 in parallel. The first resistor R1′ is disposed between the inner terminal Pi and the second terminal P2, and the second resistor R2′ is disposed between the inner terminal Pi and the third terminal P3. The second resistor R2′, the signal processor 120, and first resistor R1 are connected to the inner Pi in parallel The resistance of the second resistor R2′ is lower than the resistance of the first resistor R1′. In the preferred embodiment, the resistance of the second resistor R2′ is much lower than the resistance of the first resistor R1′. Besides, the “X” in the FIG. 7 represents the location where the tear line spans in the extending circuit 230, the tear line can spans between the second terminal P2 and the second resistor R2′, or it can spans between the inner terminal Pi and the second resistor R2′. Since the resistance of the second resistor R2′ is lower than the resistance of the first resistor R1′, when the tear line is torn, the electrical potential of the input terminal 121 of the signal processor 120 changes, it means from low electrical potential into high electrical potential. When the electrical potential of the input terminal 121 of the signal processor 120 is varied, a status of one bit of the signal processor 120 is reversed, and it can't be reversed again or is hardly to be reversed again. In the embodiments of FIG. 6 to FIG. 8, the field of application is similar to first embodiment, these can all avoid the bottle 10 to be stolen by switching bags. In addition to bottle 10, the security labels of the above-mentioned embodiments can apply to other commodity which need avoid counterfeit, for example: mitten crab or jewelry box.

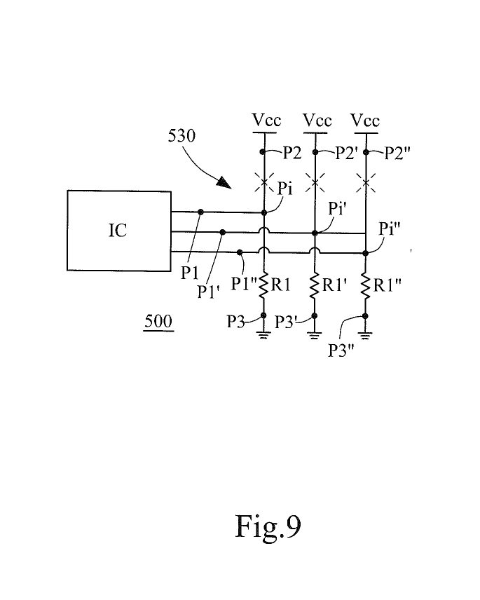

Please refer to FIG. 9. FIG. 9 is a diagram illustrating a fourth embodiment of the security label of the invention. In this embodiment, the security label has a plurality of extending circuits 530, and different first terminals of the extending circuits 530 are connected to different input terminals of the signal processor. In the FIG. 9, the “X” represents the location where the tear line spans in the extending circuit 430. Compared with the security labels of FIG. 1, FIG. 6 to FIG. 8, the security label of this embodiment has more extending circuits 530, so it is more difficult to be counterfeited.

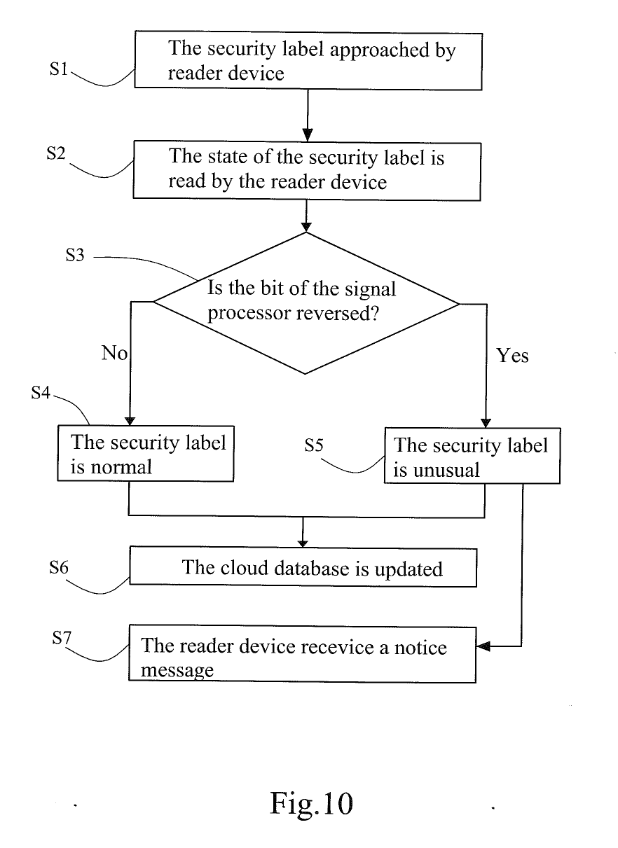

Please refer to FIG. 10. FIG. 10 shows a flow diagram of the operation of the security label. First, the reader device is used to approaches to the security label (step Si). Next, the state of the signal processor is read by the reader device via the antenna of the NFC tag (step S2). Then, the status of the security label is determined by the reader device (step S4). If the status of the bit of the signal processor has reversed, the security label would be determined to abnormal. It means the security label has be torn or remade after torn (step S5). The determining result is transmitted to the cloud database when the determining has completed (step S6). The status of the security label in the cloud database is updated by the cloud database. If the status of the security label is “reversed”, the cloud database would transmit a warning message to the reader device (step S7) to remind the consumer the commodity pasted the security label may be a fake.

Those skilled in the art will readily observe that numerous modifications and alternatives of the device and method may be made while retaining the teachings of the invention. Accordingly, the above disclosure should be construed as limited only by the meters and bounds of the appended claims.

I claim:

1. A security label configuring to read by a reader device, the security label comprising:
a substrate;
an extending circuit, disposed on the substrate; and
a signal processor, disposed on the substrate, the signal processor further having an input terminal, the input terminal connected to the extending circuit;
wherein, when the electrical potential of the input terminal is changed, a status of a bit of the signal processor is reversed

2. The security label of claim 1, wherein the substrate further comprises a tear line spanned the extending circuit.

3. The security label of claim 1, wherein the input terminal is a general input/output terminal.

4. The security label of claim 1, further comprising a plurality of extending circuit, wherein the first terminal of each extending circuit is connected to different input terminal of the signal processor.

5. The security label of claim 1, further comprising a first resistor, wherein the first resistor is connected to the signal processor in parallel.

6. The security label of claim 1, further comprising a second resistor, wherein the second resistor is connected to the signal processor in parallel, and the resistance of the second resistor lower than that of the first resistor.

7. The security label of claim 1, wherein the signal processor further comprises a NFC tag having a plurality of information.

8. The security label of claim 1, wherein the signal processor further comprises a microcontroller, and the microcontroller senses and determines the electrical potential of the input terminal.

9. The security label of claim 1, wherein the signal processor further comprises a NFC antenna, the NFC antenna is configured to receive an external electromagnetic wave.

10. The security label of claim 9, wherein the frequency of the external electromagnetic wave is between 3 MHz and 30 MHz.

11. A security method of the security label described in claim 1, the security method comprising the following steps:
A. approaching the reader device to the security label so as to read the security label; and
B. determining whether the status of the bit of the signal processor is reversed or not; wherein the security label is determined to be normal by the signal processor if the bit is not reversed, the security label is determined to be torn by the signal processor if the bit is reversed.

12. The security method of claim 11, wherein the status of the bit of the signal processor is read by the reader device via the NFC antenna.

13. The security method of claim 11, further comprising following steps:
C. transmitting a judged result to a cloud database from the reader device; and
D. transmitting a notice message to the reader device from the cloud database.
